(19) United States
(12) Patent Application Publication
(10) Pub. No.: US 2010/0085554 A1
(43) Pub. Date: Apr. 8, 2010

(54) ADAPTOR OF AN ALIGNER SYSTEM

(76) Inventors: Chih-Shen FAN, Hsinchu (TW); Li-Wei Chen, Hsinchu (TW); I-Chin Sung, Tainan (TW)

Correspondence Address: Muncy, Geissler, Olds & Lowe, PLLC, P.O. BOX 1364, FAIRFAX, VA, 22038-1364, US

(21) Appl. No.: 12/244,548

(22) Filed: Oct. 2, 2008

(51) Int. Cl. G03B 27/62

(52) U.S. Cl. 355/75; 355/77

(57) ABSTRACT

An adapter is disclosed, comprising a frame including an inner edge with a first side, a second side, a third side and a fourth side, wherein the first side and the fourth side are opposite and the second side and the third side are opposite. At least two fixed hold elements are connected to the first side of the inner edge of the frame. A plurality of first flexible clip elements are connected to the second and third sides of the inner edge of the frame. At least two second flexible clip elements are connected to the fourth side of the inner edge of the frame.

### BACKGROUND OF THE INVENTION

1. Field of the Invention

The invention relates to an adaptor, and more particularly relates to an adapter applicable in an aligner system.

2. Description of the Related Art

Microlithography refers generally to any of several processes by which patterns with small features are copied from a master image to an object such as a silicon wafer. One type of microlithography, called photolithography, is often used in semiconductor manufacturing to define a layer of an integrated circuit. In projection photolithography the image of a glass photomask is projected on a silicon wafer that is coated with a photographic emulsion or photoresist.

Sometimes, an aligner suitable for large-sized wafers, such as 12-inch wafers, is needed to expose small-sized wafers, such as 9-inch wafers and a large-sized mask corresponding to the large-sized wafer is used in the aligner. A mask suitable for a large-sized wafer has a larger size and higher cost. Meanwhile, an adapter is required for small-sized masks corresponding to smaller sized wafers when using an aligner suitable for large-sized masks corresponding to larger sized wafers.

### BRIEF SUMMARY OF INVENTION

According to the issues described, the invention provides an adapter, comprising a frame including an inner edge with a first side, a second side, a third side and a fourth side, wherein the first side and the fourth side are opposite and the second side and the third side are opposite. At least two fixed hold elements are connected to the first side of the inner edge of the frame. A plurality of first flexible clip elements are connected to the second and third sides of the inner edge of the frame. At least two second flexible clip elements are connected to the fourth side of the inner edge of the frame.

The invention further provides a mask loading process, comprising the following steps. A lithography apparatus is provided. An adapter comprising a frame including an inner edge with a first side, a second side, a third side and a fourth side is provided, wherein the first side and the fourth side are opposite and the second side and the third side are opposite. At least two fixed hold elements are connected to the first side of the inner edge of the frame. A plurality of first flexible clip elements are connected to the second and third sides of the inner edge of the frame. At least two second flexible clip elements are connected to the fourth side of the inner edge of the frame. A mask is set into a hallow region of the adapter to be fixed by the fixed hold elements and the first and second flexible clip elements. The adapter combined with the mask is loaded into the lithography apparatus.

### BRIEF DESCRIPTION OF DRAWINGS

The invention can be more fully understood by reading the subsequent detailed description and examples with references made to the accompanying drawings, wherein:

FIG. 1 shows a plan view of an adapter.

FIG. 2 shows a plan view of the adapter of FIG. 1 after a mask is loaded.

FIG. 3 shows a plan view of an adapter of an embodiment of the invention.

### DETAILED DESCRIPTION OF INVENTION

The following description is of the contemplated mode of carrying out the invention. This description is made for the purpose of illustrating the general principles of the invention and should not be taken in a limiting sense, not for limiting the invention.

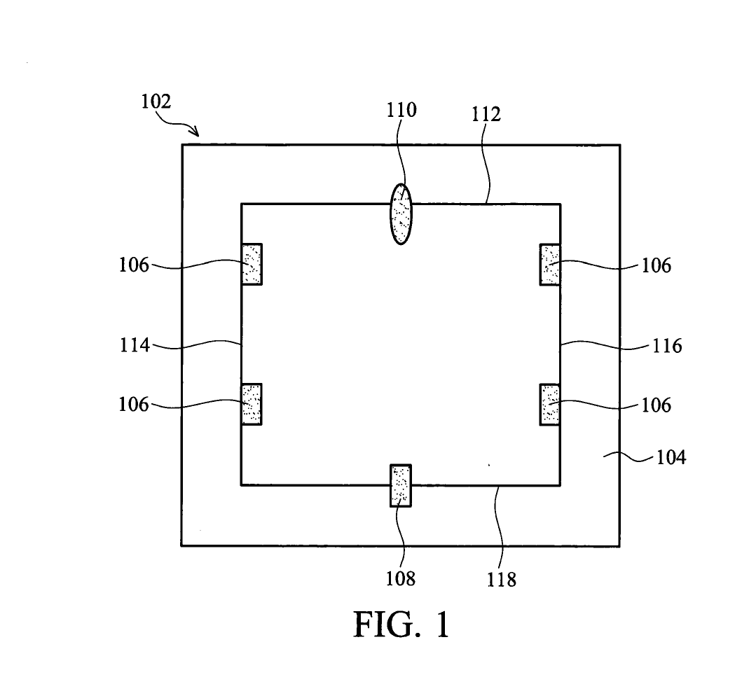

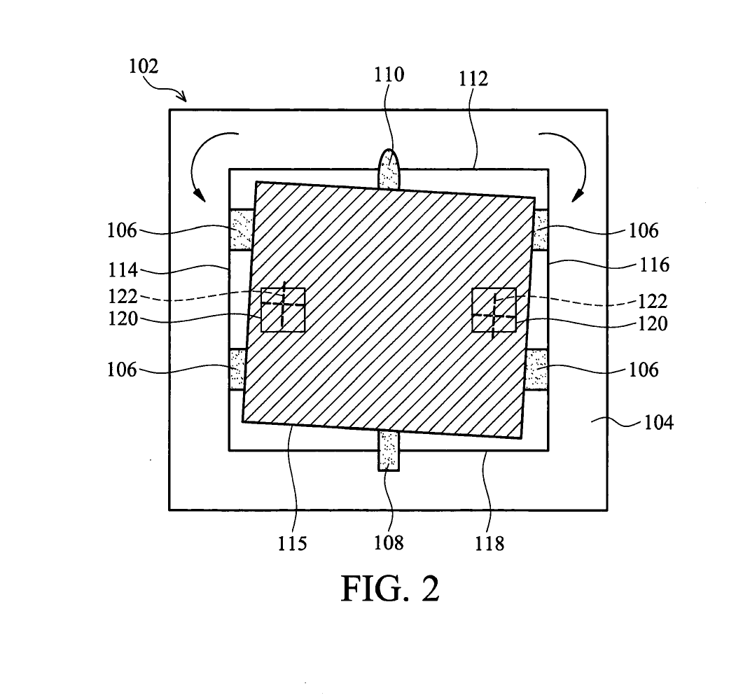

Referring to FIG. 1, which shows a plan view of an adapter 102, a frame 104 comprising a first side 112, a second side 114, a third side 116 and a fourth side 118 at the inner edge. A fixed hold element 110 is connected to the first side 112 of the inner edge of the frame 104, and first flexible clip elements 106 are connected to the second side 114 and third side 116 of the inner edge of the frame 104, and a second flexible clip element 108 is connected to the fourth side 118. Referring to FIG. 2, which shows a plan view of the adapter 102 after a mask is loaded, when the mask 115 is loaded, it is fixed by support from the fixed hold element 110 and pressure from the first flexible clip elements 106 and second flexible clip elements 108. However, as shown in the figure, the adapter 102 cannot fix the mask 115 properly because it is hard for all of the first flexible clip elements 106 and second flexible clip elements 108 to clip the mask 115 with the same strength. Therefore, the mask 115 rotates. When the issue occurs, the charge coupled devices (CCD) 120 cannot find the alignment marks 122 of the mask 115. Accordingly, mask loading accuracy is not good and alignment failure often occurs during the wafer process.

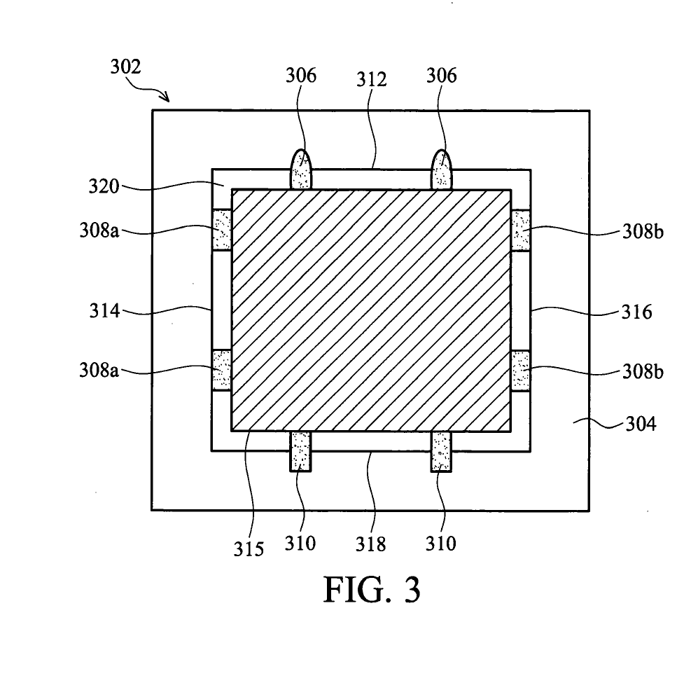

FIG. 3 shows a plan view of an adapter of an embodiment of the invention. It is noted that the adapter is not an element of the lithography apparatus, but an attachment to be combined with a small-sized mask for an aligner suitable for large-sized masks and wafers, and is used so that a small-sized mask and wafer may also be used by the large-sized mask lithography apparatus. Meanwhile, before the mask loading process, the adapter is disconnected from the aligner.

Referring to FIG. 3, the adapter 302 comprises a frame 304 which preferably is formed of metal, such as aluminum, and the frame 304 includes a first side 312, a second side 314, a third side 316 and a fourth side 318 at the inner edge. Two fixed hold elements 306 are connected to the first side 312 of the frame 304, two first flexible clip elements 308a are connected to the second side 314, two first flexible clip elements 308b are connected to the third side 316 of the frame 304, and two second flexible clip elements 310 are connected to the fourth side 318 of the frame 304.

A mask loading process of a lithography apparatus suitable for large-sized masks and wafers can be performed with the help of the adapter described. Since the lithography apparatus is designed for large-sized masks and wafers, robot arms cannot take a small-sized mask and the small-sized mask cannot be set in the lithography apparatus to perform an exposure process. The small-sized mask 115 is set into a hallow region 320 of the frame 304 of the adapter 302 and is fixed by the fixed hold elements 306 and the first and second flexible clip elements 308a, 308b and 310. In more detail, the two fixed hold elements 306 are fixed and only support the edge sidewall of the mask 315. All the first clip elements 308a and 308b and the second clip elements 310 are flexible and include the elastic element, such as springs. When the mask 315 is inputted into the adapter 302, the second clip elements 310 push the mask 315 and the first clip elements 308a, 308b clip to a portion of the bottom surface and the sidewalls of the mask 315 and the mask 315 is supported by the fixed hold element 306. Comparing to the adapter shown in FIG. 1, since the adapter 302 of the embodiment has two supporting points at the first side 312 and fourth side 318 of the inner edge of the frame 304 respectively, the mask 315 does not rotate during the mask loading process and adapter transferring process. Therefore, the issue of alignment failure from the charge coupled devices (CCD) not finding the alignment marks of the mask due to mask rotation can be eliminated and through put of the lithography apparatus can be increased.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An adapter, comprising:
a frame including an inner edge with a first side, a second side, a third side and a fourth side, wherein the first side and the fourth side are opposite and the second side and the third side are opposite;
at least two fixed hold elements connected to the first side of the inner edge of the frame;
a plurality of first flexible clip elements connected to the second and third sides of the inner edge of the frame, and
at least two second flexible clip elements connected to the fourth side of the inner edge of the frame.

2. The adapter as claimed in claim 1, wherein the adapter is for a lithography apparatus suitable for large-sized masks, and is used so that a small-sized mask may also be used by the large-sized mask lithography apparatus.

3. The adapter as claimed in claim 1, wherein the small-sized mask is inputted into a hallow region of the adapter and fixed by the fixed hold elements and first and second flexible clip elements.

4. The adapter as claimed in claim 3, wherein the fixed hold elements support the sidewalls of the mask.

5. The adapter as claimed in claim 4, wherein the second flexible clip elements support the sidewall of the mask.

6. The adapter as claimed in claim 5, wherein the first flexible clip elements clip the sidewalls and a portion of the bottom surface of the mask.

7. The adapter as claimed in claim 1, wherein the each of the first and second flexible clip elements is elastic.

8. The adapter as claimed in claim 7, wherein the elastic element is a spring.

9. The adapter as claimed in claim 2, wherein the lithography apparatus is an aligner.

10. A mask loading process, comprising:
providing a lithography apparatus;
providing an adapter comprising:
a frame including an inner edge with a first side, a second side, a third side and a fourth side, wherein the first side and the fourth side are opposite and the second side and the third side are opposite;
at least two fixed hold elements connected to the first side of the inner edge of the frame;
a plurality of first flexible clip elements connected to the second and third sides of the inner edge of the frame; and
at least two second flexible clip elements connected to the fourth side of the inner edge of the frame;
setting a mask into a hallow region of the adapter to be fixed by the fixed hold elements and the first and second flexible clip elements; and
loading the adapter combined with the mask into the lithography apparatus.

11. The mask loading process as claimed in claim 10, wherein the before loading the adapter combined with the mask into the lithography apparatus, the adapter is disconnected from the lithography apparatus.

12. The mask loading process as claimed in claim 10, wherein when the mask is set into the hallow region of the adapter, the fixed hold elements and the second flexible clip elements support the inner sidewalls of the frame, and the first flexible clip elements clip the inner sidewalls and a portion of the bottom surface of the mask, such that the mask does not rotate.

13. The mask loading process as claimed in claim 10, wherein each of the first and second flexible clip elements include an elastic element.

14. The mask loading process as claimed in claim 13, wherein the elastic element is a spring.

15. The mask loading process as claimed in claim 10, wherein the lithography apparatus is suitable for large-sized masks, and adaptable to be suitable for small-sized masks.

16. The mask loading process as claimed in claim 10, wherein the lithography apparatus is an aligner.

17. The mask loading process as claimed in claim 10, wherein a robot arm of the lithography apparatus cannot take the mask with smaller-size, but can take the adapter combined with the mask.
